(19) United States
(12) Patent Application Publication
(10) Pub. No.: US 2013/0283940 A1
(43) Pub. Date: Oct. 31, 2013

(54) WEAR COMPENSATION DEVICE FOR A GEAR SET AND ASSOCIATED MOUNTING METHOD

(71) Applicants: Jerome Boussaguet, Jundiai (BR); Sylvain Bussit, Monnaie (FR); Daniel Jansen, Tours (FR); Thomas Lepine, Villandry (FR); Bruno Montboeuf, Cerelles (FR)

(72) Inventors: Jerome Boussaguet, Jundiai (BR); Sylvain Bussit, Monnaie (FR); Daniel Jansen, Tours (FR); Thomas Lepine, Villandry (FR); Bruno Montboeuf, Cerelles (FR)

(73) Assignee: AKTIEBOLAGET SKF, Goteborg (SE)

(21) Appl. No.: 13/868,687

(22) Filed: Apr. 23, 2013

(30) Foreign Application Priority Data
Apr. 23, 2012 (FR) 1253678

(51) Int. Cl. F16H 25/08

(52) U.S. Cl. CPC F16H 25/08
USPC 74/55

(57) ABSTRACT

The wear compensation device for a gear set comprises a support for attaching the device to an external element, a bearing intended to be mounted on a shaft comprising one of the wheels of the gear set, and an eccentric mounted on the bearing and able to move angularly with respect to the support.

The support and the eccentric each delimit an axial opening having a radial dimension greater than the diameter of the bore of the bearing, the opening of the support being situated axially on the side of the opening of the eccentric with regard to the bearing.

### CROSS-REFERENCE TO RELATED APPLICATIONS

This application claims priority to French patent application no. 1253678, filed Apr. 23, 2012, the contents of which are fully herein incorporated by reference.

### FIELD OF THE INVENTION

The present invention relates to the field of wear compensation devices for gear sets, used notably in power steering mechanisms for motor vehicles.

### BACKGROUND OF THE INVENTION

An power steering mechanism comprises an electric assisting steering motor and a worm mounted on an output shaft of the said motor and meshing with a gear wheel for example attached to the steering column shaft or connected to the steering rack via an intermediate pinion.

In general, the power steering mechanism further comprises a system for automatically compensating for the wearing of the thread or threads of the worm and/or of the teeth of the associated gear wheel which may occur over the course of time. For further details, reference may, for example, be made to document DE-A1-100 53 183 which illustrates such a wear compensation system.

In that document, the wear compensation system notably comprises an eccentric mounted at one end of the worm via a rolling-contact bearing and coming into radial contact in the bore of a tubular housing, a rotation-proofing element mounted on the eccentric and a torsion spring mounted between the said rotation-proofing element and the eccentric in order constantly to apply a circumferential force to the eccentric.

The wear compensation system described in that document has the notable disadvantage of requiring a great many assembly operations. Moreover, when the worm is being mounted in the bore of the rolling-contact bearing, the internal dimensional characteristics of the said bearing may become altered.

The present invention seeks to overcome these disadvantages. More specifically, the present invention seeks to provide a wear compensation device for a gear set that is easy to manufacture and to assemble, and is of small bulk and economical.

### SUMMARY OF THE INVENTION

In one embodiment, the wear compensation device for a gear set comprises a support for attaching the device to an external element, a bearing intended to be mounted on a shaft comprising one of the wheels of the gear set, and an eccentric mounted on the bearing and able to move angularly with respect to the support. The support and the eccentric each delimit an opening having a radial dimension greater than the diameter of the bore of the bearing. The opening of the support is situated axially on the side of the opening of the eccentric with regard to the bearing.

The eccentric may be able to move angularly with respect to the support about an axis that is radially offset with respect to an axis of the bearing.

In one embodiment, the bearing comprises an inner ring intended to be mounted on the shaft comprising one of the gear wheels and an outer ring on which the eccentric is mounted. The bearing may also comprise at least one row of rolling elements arranged between the said rings.

Each of the said openings of the support and the eccentric may have a radial dimension that is greater than or equal to the diameter of the external surface of the inner ring of the bearing.

In one embodiment, the device comprises a removable cover mounted on the support and able to close off the said openings.

Advantageously, the eccentric comprises retaining means able to collaborate with the support to retain the eccentric axially relative to the said support. For preference, the retaining means are offset radially outwards with respect to the bore of the bearing.

In one embodiment, the device comprises an actuator mounted axially between the support and the eccentric and able to apply a circumferential force to the said eccentric.

For preference, the eccentric comprises a centring portion for centring the actuator. Advantageously, the actuator extends axially partly inside a recess of the eccentric. In one embodiment, the actuator is a spring having a first end attached to the eccentric and an opposite second end attached to the support.

According to another aspect, the invention also relates to an assisted steering mechanism for a motor vehicle comprising a wear compensation device as defined hereinabove.

According to another aspect, the invention further relates to a method of assembling a wear compensation device as defined hereinabove, in which a tool is introduced into the opening of the support and/or into the opening of the eccentric, the said tool is brought to press against the bearing, then the shaft is mounted into the bore of the bearing while keeping the tool pressed against the said bearing.

### BRIEF DESCRIPTION OF THE DRAWINGS

The present invention will be better understood from a study of the detailed description of some embodiments considered solely by way of nonlimiting examples and illustrated by the attached drawings in which:

FIG. 1 is a view in axial section of a wear compensation device according to a first embodiment of the invention associated with a worm and wheel,

FIG. 2 is a view in axial section of the device of FIG. 1 prior to mounting,

FIGS. 3 and 4 are exploded perspective views of the device of FIG. 2,

FIG. 5 is a view in axial section of the device of FIGS. 1 to 4 during mounting,

FIG. 6 is a view in axial section of a wear compensation device according to a second embodiment of the invention, prior to mounting,

FIG. 7 is a view in axial section of a wear compensation device according to a third embodiment of the invention, prior to mounting, and

FIGS. 8 and 9 are exploded perspective views of the device of FIG. 7.

### DETAILED DESCRIPTION OF THE INVENTION

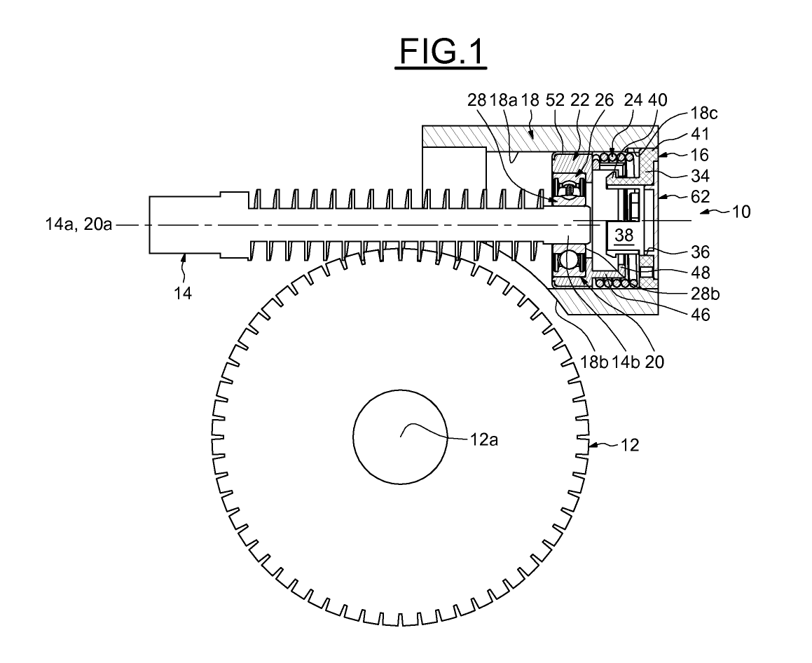

In FIG. 1, a wear compensation device, referenced 10 overall, is associated with a gear set of the worm 14 and wheel 12 type. The gear set illustrated is a skew-axes gear set and the axes 12a, 14a of the gear wheel and of the worm are orthogonal.

The device 10 comprises a support 16 intended to be attached to a tubular housing 18 of the worm which is external to the said device, a rolling-contact bearing 20 mounted on an end journal 14b of the worm, an eccentric 22 mounted on the rolling-contact bearing and intended to come directly or indirectly into contact with the housing, and a torsion spring 24 constantly to apply a circumferential force between the support 16 and the said eccentric. The worm 14 extends axially partly into a bore 18a of the housing 18. The housing comprises, at one axial end of the bore 18a, an opening 18b through which the gear wheel 12 can pass so that the thread or threads of the worm mesh with the toothset of the wheel.

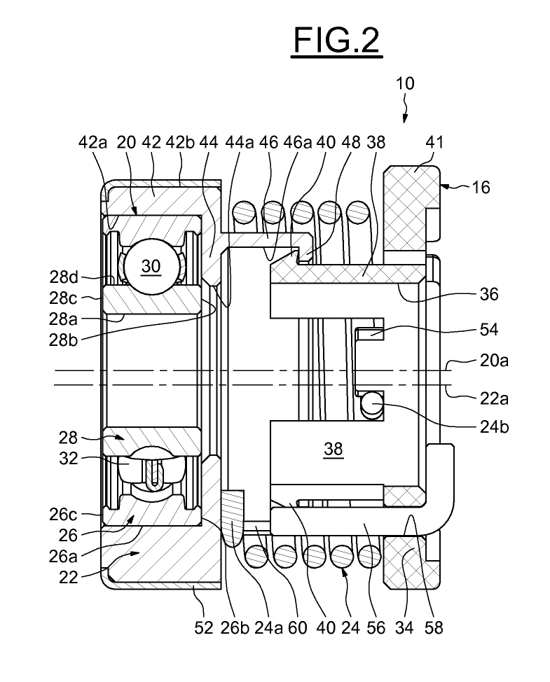

The bearing 20 has an axis 20a of rotation coaxial with the axis 14a of the worm. As illustrated more visibly in FIG. 2, the bearing 20 comprises an outer ring 26 on which the eccentric 22 is mounted, an inner ring 28 designed to be mounted on the journal 14b of the worm, a plurality of rolling elements 30, here produced in the form of balls, and a cage 32 for maintaining the even circumferential spacing of the rolling elements.

The outer ring 26 comprises a cylindrical axial outer surface 26a on which the eccentric 22 is mounted, a stepped bore, two opposite frontal radial surfaces 26b and 26c and a deep-groove raceway formed substantially in the middle of the bore and having in cross section a concave internal profile suited to the rolling elements 30, the said raceway facing radially inwards.

The inner ring 28 comprises a cylindrical bore 28a in which the journal 14b of the worm is mounted, two opposite radial frontal surfaces 28b and 28c, a cylindrical axial outer surface 28d, and a deep-groove raceway formed substantially in the middle of the outer surface 28d and having in cross section a concave internal profile suited to the rolling elements 30, the said raceway facing radially outwards. The frontal surface 28b, 28c is situated in a radial plane containing the respective frontal surface 26b, 26c of the outer ring.

In the embodiment illustrated, the outer ring 14 and the inner ring 16 are solid. What is meant by a “solid ring” is a ring the shape of which is obtained by machining with the removal of chips (by turning or grinding) from tubes, bar stock, forged and/or rolled blanks.

The fixed support 16 comprises an annular radial wall 34 comprising a cylindrical axial bore 36 that has a diameter greater than the diameter of the bore 28a of the inner ring of the bearing. The diameter of the bore 36 is also greater than the diameter of the outer surface 28d of the said inner ring. As will be described in greater detail later on, the bore 36 of the fixed support forms an axial opening which, during a mounting step, allows the introduction of a tool intended to come to press axially against the inner ring 28.

The support 16 also comprises a plurality of axial tabs 38 extending from the radial wall 34 axially on the side of the eccentric 22 and of the bearing 20. The tabs 38 partially extend the bore 36 of the support in an axial direction and are spaced apart evenly in the circumferential direction. In the embodiment illustrated, there are three of these tabs 38. Each tab 38 at its free end has a hook 40 extending radially outwards and designed to collaborate with the eccentric 22 in order to secure the support 16 and the said eccentric axially.

The support 16 further comprises, at the cylindrical exterior surface of the radial wall 34, a radial protrusion 41 designed to become lodged in a groove 18c (FIG. 1) of corresponding shape formed at one axial end of the bore 18a of the housing. The groove 18c extends radially outwards from the bore 18a. The support 16 may for example be made of a single piece by moulding a synthetic material.

The eccentric 22 is able to move angularly with respect to the fixed support 16, to the inner ring 28 of the bearing, to the housing 18 and to the worm 14. The eccentric 22 may, for example, be made as a single piece of a metallic material or alternatively by moulding a synthetic one.

The eccentric 22 comprises a large-diameter annular axial portion 42 having a cylindrical bore 42a in which the outer ring 26 of the bearing is tightly mounted, and with a cylindrical outer surface 42b, of axis 22a which is parallel to and radially offset with respect to the axis 20a of the bearing. The outer surface 42b of the bore may come directly or indirectly into contact with the housing 18.

The eccentric 22 further comprises an annular radial portion 44 extending radially inwards the end of the axial portion 42 that is situated on the same side as the fixed support 16, and a small-diameter annular axial portion 46 extending axially the said radial portion on the opposite side to the large-diameter axial portion 42. The axial portion 46 extends axially towards the support 16 and partially radially surrounds the tabs 38 of the support. The radial portion 44 forms an axial thrust surface for the radial surface 26b of the outer ring of the bearing. The axial bore 44a of the radial portion 44 here has a diameter substantially equal to the diameter of the outer surface 28d of the inner ring. The axial bore 46a of the axial portion 46 has a diameter greater than the diameter of the said outer surface 28d. The bores 44a, 46a form a stepped axial opening of the eccentric 22 having a radial dimension at least equal to the diameter of the outer surface 28d of the inner ring. The opening of the eccentric 22 is situated axially on the side of the bore 36 of the support with regard to the inner ring 28 and more generally with regard to the bearing 20.

The eccentric 22 also comprises an annular protrusion 48 provided at the free end of the axial portion 46 and extending radially inwards in the direction of the tabs 38. The protrusion 48 remains radially distant from the tabs. The protrusion 48 is situated axially between the hooks 40 and the radial wall 34 of the support 16. The protrusion 48 has an inside diameter less than the outside diameter of the hooks 40 so that axial retention of the eccentric 22 relative to the fixed support 16 can be achieved through a diametral interference fit. The protrusion 48 and the hooks 40 form complementary means that collaborate with one another to secure the eccentric 22 and the support 16 axially so that the device 10 forms a one-piece unit that can be handled, transported and mounted without the risk of its constituent elements becoming axially separated. The protrusion 48 and the hooks 40 are offset radially outwards with respect to the inner ring 28.

The device 10 also comprises a plain ring 52 pressed onto the outer surface 42b of the axial portion 42 of the eccentric, and which is designed to come radially into contact with the bore 18a of the housing 18. As an alternative, it might be possible not to provide the ring 52 and to directly mount the axial portion 42 of the eccentric against the bore 18a of the housing.

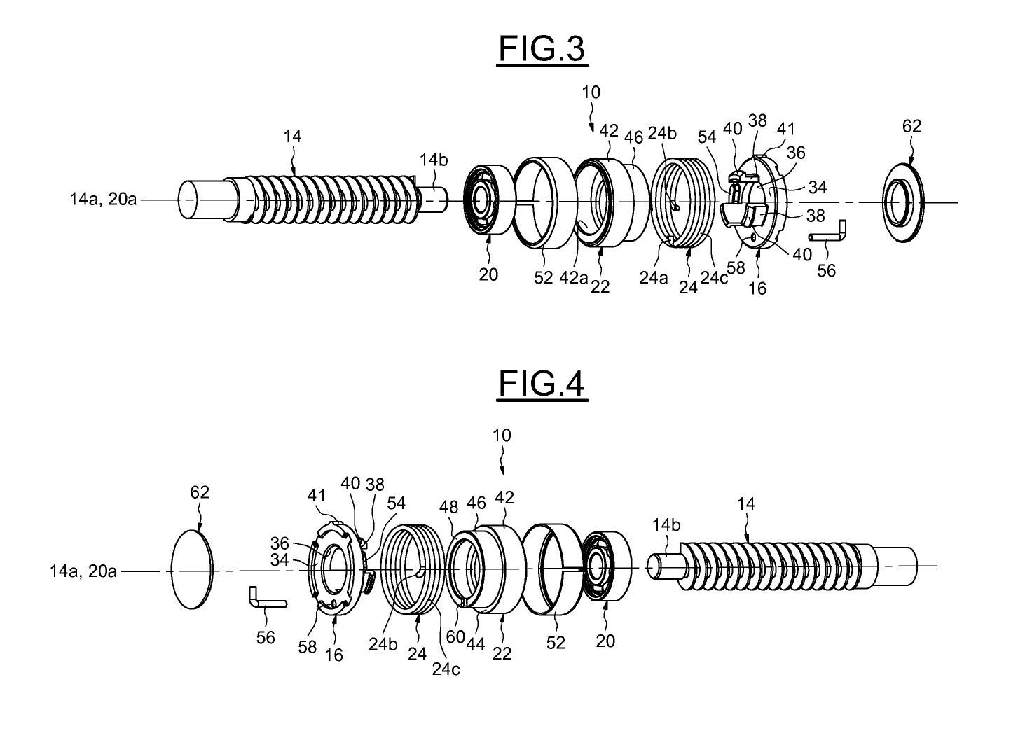

The eccentric 22 and the support 16 between them delimit an axial space in which the torsion spring 24 is placed. The spring 24 radially surrounds the axial portion 46 of the eccentric forming a centring portion for the said spring. The spring, which is coaxial with the axis 20a of the bearing, has a first end 24a that is mounted inside a complementary housing formed in the thickness of the eccentric 22 at the base of the axial portion 46. The spring 24 also has an opposite, second, end 24b (FIG. 3) which catches in the circumferential direction on a protrusion 54 formed on the radial wall 34 of the fixed support axially on the same side as the tabs 38. The spring 24 further comprises a working part 24c connecting the said ends 24a, 24b and being wound radially around the axial portion 46 of the eccentric and around the tabs 38 of the fixed support. In the embodiment illustrated, the turns of the spring 24 in cross section exhibit a circular profile. As an alternative, it is of course possible to conceive of turns that have some different profile, for example a square one.

When the device 10 is in the as-delivered condition as illustrated in FIG. 2, namely after its constituent elements have been assembled and before it is mounted on the worm 14, the spring 24 applies an axial preload to the support 16 and to the eccentric 22. The axial preload applied by the spring 24 encourages axial contact between the protrusion 48 of the eccentric and the hooks 40 of the support. The spring 24 also applies an angular preload to the support 16 and to the eccentric 22.

In order to prevent the eccentric 22 from rotating relative to the support 16 when the device 10 is in the assembled state prior to being mounted, the said device comprises a pin 56 extending both into a hole 58 made in the thickness of the radial wall 34 of the support and into an axial groove 60 (FIGS. 2 and 4) formed starting from the protrusion 48 and extending axially into the thickness of the axial portion 46 of the eccentric. The hole 58 and the groove 60 are axially aligned. The pin 56 forms a rotation-proofing means able to maintain the desired predetermined angular position of the eccentric 22 relative to the support 16. When the device 10 is in the assembled state, the circumferential preload force applied by the torsion spring 24 is dependent on the chosen relative angular positioning of the housing of the eccentric in which the first end 24a of the spring is mounted, of the protrusion 54 of the support on which the second end 24b of the spring is mounted, and of the hole 58 of the said support.

The device 10 further comprises a removable cover 62 (FIGS. 1, 3 and 4) designed to be mounted on the fixed support 16 against the radial wall 34 axially on the opposite side to the tabs 38. The cover 62 is centred in the bore 36 of the support and serves to close off the said bore and the hole 58 in the support axially on the opposite side to the bearing 20. The cover 62 also serves to close off the opening of the eccentric 22. The cover 62 allows the support 16 and the eccentric 22 to be closed off axially on the opposite side to the bearing 20.

To mount the device 10 onto the worm 14 and the housing 18, the procedure is as follows. In a first step, the one-piece unit formed of the bearing 20, the eccentric 22 provided with the ring 52, the spring 24, the support 16 and the pin 56, is brought into the bore 18a of the housing. The one-piece unit is introduced into the bore 18a by axial sliding such that the protrusion 41 of the support 16 becomes lodged in the groove 18c of the housing. In this pre-assembled position, the eccentric 22 is in radial contact with the bore 18a of the housing via the ring 52. In a second step, the support 16 is immobilized with respect to the housing 18, for example by upsetting or by clinching, or alternatively by mounting a circlip between the support and the housing.

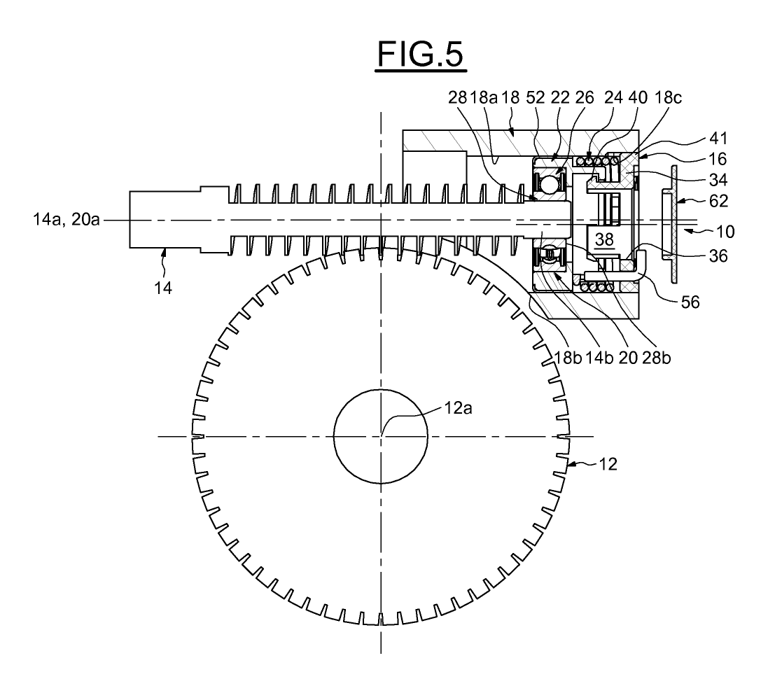

In a third step, a tool (not depicted) is introduced axially from the outside into the bore 36 of the fixed support and into the opening of the eccentric 22 which is formed by the bores 44a, 46a. The tool is introduced into the fixed support 16 and into the eccentric 22 until it comes to press against the radial surface 28b of the inner ring of the bearing. Next, in a fourth step, the journal 14b of the worm is pressed, axially from the opposite side to the tool, into the bore 28a of the inner ring. During the latter step, the tool is kept pressed against the radial surface 28b of the inner ring so as to avoid transmitting the press-mounting force through the rolling elements 30, because such transmission would carry the risk of creating indentations on the raceways or races and therefore of causing premature bearing failure. The tool keeps the inner ring 28 in position. The mounting of the worm 14 inside the inner ring 28 of the bearing has a tendency to cause the bearing 20 of the eccentric 22 to shift slightly in the axial direction towards the support 16. After the worm 14 has been mounted, some axial clearance remains between the protrusion 48 of the eccentric and the hooks 40 of the support, as has been illustrated in FIG. 5.

In a fifth step, the pin 56 is removed from the eccentric 22 and from the support 16. Under the effect of the angular preload of the spring 24, the eccentric 22 is made to rotate about the axis 22a with respect to the housing 18, to the support 16, to the inner ring 28 and to the worm 14 into a position such as that illustrated in FIG. 1. This causes a radial movement of the bearing 20 and of the worm 14 towards the gear wheel 12. Thus, the thread or threads of the worm 14 and the teeth of the wheel 12 mesh without lash. Finally, in a sixth and final step, the cover 62 is mounted to the support 16.

During operation, the spring 24 constantly applies a circumferential force or torque to the eccentric 22 that has a tendency constantly to push the said eccentric, the bearing 20 and the worm 14 back radially towards the wheel 12. That makes it possible automatically to compensate for wear to the thread or threads of the worm 14 and/or to the teeth of the gear wheel 12 which may occur over the course of time. What actually happens in the event of wear is that the circumferential force constantly applied by the spring 24 to the eccentric 22 makes it possible to cause the said eccentric to move angularly with respect to the housing 18 and to the support 16, causing the rolling-contact bearing 20 and the worm 14 to move radially towards the wheel 12.

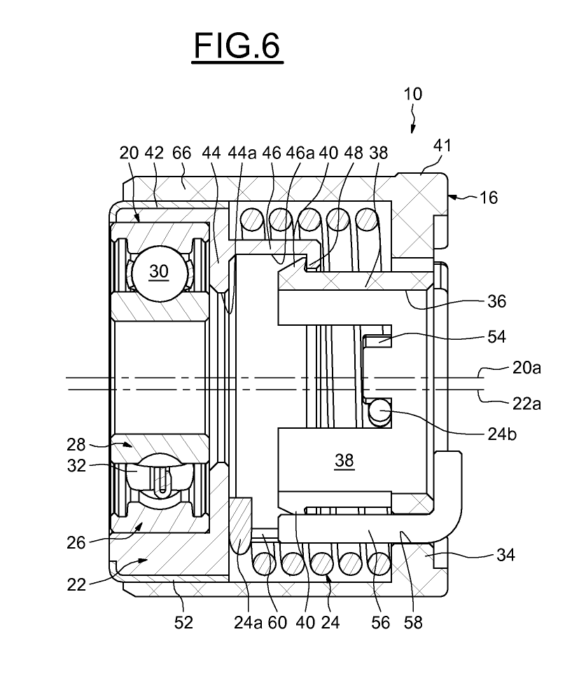

The embodiment illustrated in FIG. 6, in which elements which are identical bear the same references, differs from the embodiment described previously in that the support 16 comprises an annular axial portion 66 extending axially from the radial wall 34 and radially surrounding the tabs 38. The axial portion 66 extends axially beyond the tabs 38 so as to form an annular housing in which the eccentric 22 and the bearing 20 are mounted. The ring 52 presses radially against the bore of the axial portion 66 of the support. In the position in which it has been mounted into the housing, the outer surface of the axial portion 66 of the support presses radially against the bore of the housing. The eccentric 22 is able to move angularly inside the axial portion 66 of the fixed support. In this embodiment, the eccentric 22 and the support 16 axially and radially delimit the space in which the spring 24 is placed.

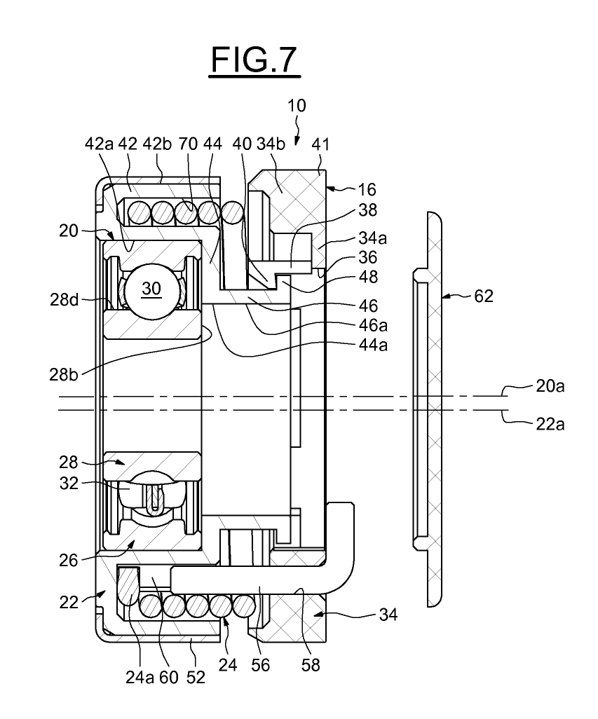

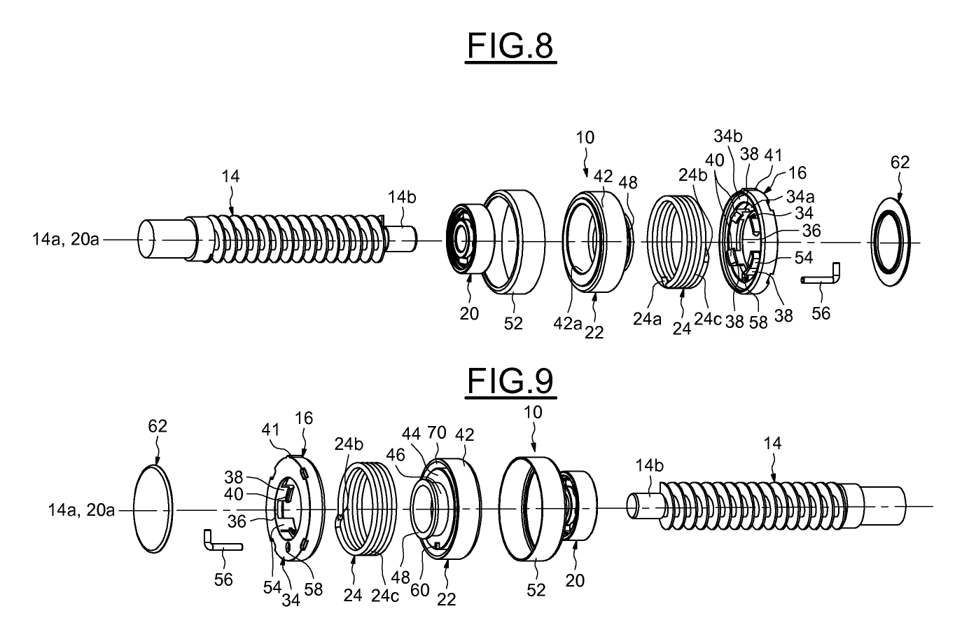

The embodiment illustrated in FIGS. 7 to 9, in which elements which are identical bear the same references, differs notably from the first embodiment in that the axial portion 46 of the eccentric has a smaller diameter and extends axially from the small-diameter edge of the radial portion 44, the annular protrusion 48 of the eccentric extending radially outwards. The diameter of the bores 44a and of the bores 46a of the radial and axial portions of the eccentric are equal. The said bores form an axial opening of the eccentric that has a radial dimension greater than the diameter of the outer surface 28d of the inner ring.

In this embodiment, the tabs 38 of the fixed support have a smaller axial dimension and partially radially surround the axial portion 46 of the eccentric. In this instance there are four of these tabs 38. The hooks 40 of the tabs extend radially inwards and have an inside diameter less than the outside diameter of the protrusion 48 so that the eccentric 22 can be retained axially relative to the fixed support 16 through a diametral interference fit. The protrusion 48 and the hooks 40 are offset radially outwards with respect to the inner ring 28.

The radial wall 34 of the fixed support is made up of a first annular radial part 34a of small thickness and small diameter and of a second annular radial part 34b extending the first part radially outwards and having a greater axial thickness. The tabs 38 extend axially from the first radial part 34a which delimits the bore 36. The diameter of the bore 36 of the support is greater than the diameter of the outer surface 28d of the inner ring and greater than the diameter of the bores 44a, 46a of the eccentric. In this embodiment, the protrusion 54 of the support on which the second end 24b of the spring catches extends from the first radial part 34a of the radial wall 34. The second radial part 34b of the wall forms a bearing surface for the spring 24.

In order to reduce the axial size of the device 10, the eccentric 22 comprises, at the axial portion 42, an annular axial recess 70 formed starting from that face of the radial portion 44 that axially faces the support 16 and into which the spring 24 partially extends. The first end 24a of the spring is mounted inside a complementary housing formed in the thickness of the axial portion 42 situated radially between the recess 70 and the outer ring 26 of the bearing. The axial portion 42 of the eccentric forms a centring portion for centring the spring 24. The groove 60 in which the pin 56 for preventing the eccentric 22 from rotating relative to the support 16 is housed is provided in this instance on the axial portion 42 of the eccentric and opens in the region of the radial portion 44.

When the device 10 is being mounted, the tool used for holding the inner ring 28 in position while the worm is being press-mounted into its bore is introduced through the bore 36 of the support and the bore 44a, 46a of the eccentric until it comes to press against the radial surface 28b of the said inner ring.

The fact that an axial opening of a radial dimension greater than the inside diameter of the radial surface 28b of the inner ring is provided on the eccentric 22 and on the fixed support 16 means that the said radial surface can be left at least partially free so that it can be used as a reference surface for bringing the tool up against the inner ring during mounting. The eccentric 22 and the fixed support 16 leave the radial surface 28b of the inner ring free.

In the embodiments illustrated, the bearing is a rolling-contact bearing. As an alternative, the bearing could be a sliding-contact bearing comprising two rings mounted pressing radially against one another, or even a bushing or a plain bearing bush.

In the embodiments illustrated, the wear compensation device is used for a gear set of the worm and wheel type that can be mounted in an power steering mechanism. However, the device may be used for other types of skew-axis or intersecting-axis gear sets, for example a set of gear wheels, a bevel gear set, a rack and pinion gear set, and be used in other applications.

1. A wear compensation device for a gear set, the wear compensation device comprising:
a support for attaching the device to an external element,
a bearing intended to be mounted on a shaft comprising one of the wheels of the gear set, and
an eccentric mounted on the bearing and able to move angularly with respect to the support,
the support and the eccentric each delimiting an axial opening having a radial dimension greater than the diameter of the bore of the bearing, the opening of the support being situated axially on the side of the opening of the eccentric with regard to the bearing.

2. The wear compensation device according to claim 1, wherein the eccentric is able to move angularly with respect to the support about an axis that is radially offset with respect to an axis of the bearing.

3. The wear compensation device according to claim 1, wherein the bearing includes an inner ring mounted on the shaft and an outer ring on which the eccentric is mounted.

4. The wear compensation device according to claim 3, wherein the bearing further comprises at least one row of rolling elements arranged between the rings.

5. The wear compensation device according to claim 3, wherein each of the openings has a radial dimension that is greater than or equal to the diameter of the external surface of the inner ring of the bearing.

6. The wear compensation device according to claim 1, further comprising a removable cover mounted on the support and able to close off the said openings.

7. The wear compensation device according to claim 1, wherein the eccentric provides retaining means able to collaborate with the support to retain the eccentric axially relative to the support.

8. The wear compensation device according to claim 7, wherein the retaining means are offset radially outwards with respect to the bore of the bearing.

9. The wear compensation device according to claim 1, further comprising an actuator mounted axially between the support and the eccentric and able to apply a circumferential force to the said eccentric.

10. The wear compensation device according to claim 9, wherein the eccentric further comprises a centring portion for centring the actuator.

11. The wear compensation device according to claim 9, wherein the actuator extends axially partly inside a recess of the eccentric.

12. The wear compensation device according to claim 9, wherein the actuator is a spring having a first end attached to the eccentric and an opposite second end attached to the support.

13. A power steering mechanism for a motor vehicle comprising:
a wear compensation device having;
a support for attaching the device to an external element,
a bearing intended to be mounted on a shaft comprising one of the wheels of the gear set, and
an eccentric mounted on the bearing and able to move angularly with respect to the support,
the support and the eccentric each delimiting an axial opening having a radial dimension greater than the diameter of the bore of the bearing, the opening of the support being situated axially on the side of the opening of the eccentric with regard to the bearing.

14. (canceled)
